(19) United States
(12) Patent Application Publication
(10) Pub. No.: US 2026/0014533 A1
(43) Pub. Date: Jan. 15, 2026

(54) STATIC MIXER ELEMENT

(71) Applicant: COMMONWEALTH SCIENTIFIC AND INDUSTRIAL RESEARCH ORGANISATION, Acton, Australian Capital Territory (AU)

(72) Inventors: Gerald Pereira, Acton, Australian Capital Territory (AU); David Howard, Acton, Australian Capital Territory (AU); Paulus Lahur, Acton, Australian Capital Territory (AU); Michael Breedon, Acton, Australian Capital Territory (AU); Philip Kilby, Acton, Australian Capital Territory (AU)

(21) Appl. No.: 19/130,468

(22) PCT Filed: Nov. 15, 2023
(86) PCT No.: PCT/AU2023/051155

§ 371 Date: May 15, 2025

(30) Foreign Application Priority Data
Nov. 18, 2022 (AU) 2022903488
Nov. 18, 2022 (AU) 2022903490

(51) Int. Cl. B01F 25/431; B01F 101/00

(52) U.S. Cl. CPC B01F 25/43171; B01F 25/4319; B01F 2101/2204

(57) ABSTRACT

This disclosure relates to a static mixer element comprising an elongated integral scaffold, wherein the scaffold comprises plurality of polytope projections in (i) a radially or axially arranged network or (ii) a spiral ribbon of polytope projections to define a plurality of passages configured for mixing one or more fluidic reactants during flow and reaction thereof through the mixer, wherein the static mixer element comprises at least one elongated support member, wherein at least a portion of the plurality of projections are in connection with the elongated support member.

### CROSS-REFERENCE TO RELATED APPLICATIONS

The present application claims priority from Australian Provisional Patent Application No 2022903490 filed on 18 Nov. 2022 and Australian Provisional Patent Application No. 2022903488 filed on 18 Nov. 2022, the contents of which are incorporated herein by reference in their entirety.

### TECHNICAL FIELD

The present invention relates to the field of computer-assisted design of complex geometries. In particular, the present invention relates to iterative computer-assisted design of mixing devices. The present invention relates to static mixers.

### BACKGROUND

Fluid flow through mixing devices, in particular static mixers is important in a variety of industries such as chemical and bio-chemical synthesis, extraction processes, and polymer synthesis. The geometry of the static mixers, through which fluid is forced within the processing component, plays a fundamental role in determining how well the processing component performs for a specific application.

There are numerous unique geometries for static mixers and the geometries of high performing static mixers can be intricate and complex. It is desirable to be able to identify a geometry for a static mixer that will perform well for an intended specific application, whilst ameliorating the high cost associated with the manufacture of several designs and re-designs, and experimental testing of each candidate static mixer design before identifying the most suitable mixer design for a given application that are capable of providing more efficient fluid mixing or flow. For example in the mixing of emulsions, chemical reactions including reactions of liquids and/or gases, chemical adsorption including metal extraction, heat transfer and catalytic reaction of reactant chemical and/or electrochemical reactants.

### SUMMARY

The present inventors have undertaken significant research and development into alternative improved mixer devices (e.g. static mixers) and have advantageously identified a computational workflow that can predict the optimal design (i.e., solid geometry) for certain fluid flow applications. It has been found that there are two (independent) components to the design process. Firstly, an underlying (numerical) physical model which can allow a user to obtain useful quantitative measures which can be then used to assess the suitability of a particular computer design. Secondly, an Artificial Intelligence (AI) algorithm that can take into consideration the measures from the numerical model and then based on these predict enhanced mixer geometries which improve the performance a mixer device for a given application.

Accordingly, in a first aspect there is provided a static mixer element comprising an elongated integral scaffold, wherein the scaffold comprises a radially or axially arranged network or a spiral ribbon of polytope projections to define a plurality of passages configured for mixing one or more fluidic reactants during flow and reaction thereof through the mixer. The static mixer element further includes at least one elongated support member, wherein at least a portion of the projections are in connection with the elongated support element.

In a further embodiment of the first aspect, the projections may extend radially or axially to form an outer perimeter of the static mixer element. In a particular embodiment, the projections may extend radially to form an outer perimeter of the static mixer element. In an embodiment of the first aspect, the projections can form a continuous network of passages arranged in multiple orientations relative to one another. The projections may be polytope structures repeated periodically or non-periodically along the longitudinal axis of the elongated support member. In a particular embodiment, the projections may be polytope structures repeated periodically along the longitudinal axis of the elongated support member. In some embodiments of the first aspect, the projections may be the same polytope structures or may be selected from at least two different types of polytope structures. In some embodiments of the first aspect, the polytope structure may be a 2-dimensional polygon structure or a 3-dimensional polyhedron structure.

In some embodiments of the first aspect, the projections may be connected to each other via at least a portion of at least one surface of a projection to form a continuous interconnected network of projections. In some embodiments of the first aspect, at least a portion of the interconnected network of projections may be structurally connected to at least one elongated support member.

In a second aspect there is provided a static mixer element comprising an elongated integral scaffold, wherein the scaffold comprises an interconnected network of spiral ribbon projections of polytope structures that form a plurality of passages configured for mixing one or more fluidic reactants during flow and reaction thereof through the mixer, and at least one elongated support member, wherein at least a portion of the projections are in connection with the elongated support element.

In an embodiment of the second aspect, the scaffold comprises at least two spaced apart elongated support members that are structurally connected via the interconnected network of projections. In some embodiments of the second aspect, the projections may extend radially or axially from the elongated support members to form an outer perimeter of the element. In a particular embodiment of the second aspect, the projections may extend radially from the elongated support members to form an outer perimeter of the element.

In some embodiments of the second aspect, the projections may be polytope structures repeated periodically or non-periodically along the longitudinal axis of the elongated support member. In a particular embodiment of the second aspect, the projections may be polytope structures repeated periodically along the longitudinal axis of the elongated support member. The projections may be the same polytope structures or may be selected from at least two different types of polytope structures. In some embodiments of the second aspect, the polytope structure may be a regular or irregular triangular shaped polytope, preferably an irregular shaped polytope. In some embodiments of the second aspect, the polytope structure may be a 2-dimensional polygon structure or a 3-dimensional polyhedron structure.

In some embodiments of the second aspect, the projections may be connected to each other via at least a portion of at least one surface of a projection to form a continuous interconnected network of projections.

In a third aspect there is provided a static mixer element comprising an elongated integral scaffold, wherein the scaffold comprises two or more sets of projections, wherein each set of projections are spaced apart from each other and extend radially or axially from a centrally located elongated support member to define a plurality of passages configured for mixing one or more fluidic reactants during flow and reaction thereof through the mixer.

In some embodiments of the third aspect, the projections may extend radially to form an outer perimeter of the static mixer element. In some embodiments of the third aspect, each set of projections may comprise polytope structures repeated periodically or non-periodically along the longitudinal axis of the elongated support member. In a particular embodiment of the third aspect, each set of projections may comprise polytope structures repeated periodically along the longitudinal axis of the elongated support member In some embodiments of the third aspect, the polytope structure may be an elongated polyhedron structure. For example, the elongated polyhedron structure may be cylindrical structure.

In some embodiments of the third aspect, each set of projections may be equally spaced apart from each other forming segments, wherein each segment comprises at least two sets of projections. In some embodiments of the third aspect, each segment may be equally spaced apart from each other.

In embodiments of any one of the first, second or third aspects, at least a portion of a surface of the scaffold may comprise comprises a catalytic material for providing the surface with catalytically reactive sites. The catalytically reactive sites may be provided by at least one of: the scaffold being formed from a catalytic material; a catalyst material being intercalated, interspersed and/or embedded with at least part of the scaffold; and at least a part of the surface of the scaffold comprising a coating comprising a catalyst material.

In embodiments of any one of the first, second or third aspects, the length (in mm) of the elongated support member may be in a range between 1 and 5000.

In embodiments of any one of the first, second or third aspects, the diameter (in mm) of the elongated support member may be in a range between 1 and 5000.

In embodiments of any one of the first, second or third aspects, the area (in m²) of the elongated support member may be in a range between 0.001 and 1000.

In embodiments of any one of the first, second or third aspects, the length (in mm) of the projections may be in a range between 1 and 500.

In embodiments of any one of the first, second or third aspects, the diameter (in mm) of the projections may be in a range between 1 and 50.

In embodiments of any one of the first, second or third aspects, the area (in m²) of the projections may be in a range between 0.001 and 1.

In embodiments of any one of the first, second or third aspects, the scaffold comprises or consists of a metal, metal alloy, metal oxide, ceramic, cermet, composites, polymers, glasses, natural products, or combinations or derivatives thereof.

In embodiments of any one of the first, second or third aspects, the static mixer element has a diameter (in mm) in the range of 1 to 5000.

In a fifth aspect there is provided a catalytic static mixer element comprising catalytic reactive sites on the surface of the static mixer according to any embodiment described herein.

In a sixth aspect there is provided a continuous flow chemical reactor for use in reaction of one or more fluidic reactants comprising one or more static mixer elements or catalytic static mixer elements according to any embodiment as described herein.

In a seventh aspect there is provided a system for providing a continuous flow chemical reaction comprising:
a continuous flow chemical reactor comprising a static mixer or catalytic static mixer according to any embodiment as described herein;
a pump for providing fluidic flow for one or more fluidic reactants and any products thereof through the reactor;
one or more heat exchangers to allow for control of the temperature of the reactor, chamber section, static mixer, or fluidic components thereof; and
a controller for controlling one or more of the parameters of the system selected from concentration, flow rate, temperature, pressure, and residence time, of the one or more fluidic reactants, or sources or products thereof.

In an eighth aspect there is provided a process for extracting a substance from one or more fluidic reactants, the process comprising the steps of:
providing a continuous fluid flow reactor or a system according to any described herein;
providing at least a first fluidic reactant to the reactor via the one or more reactant inlets;
operating the reactor, or control means thereof, to provide flow and reaction of the at least first fluidic reactant through the static mixer; and
adsorption of a substance from the at least first reactant to at least a portion of the surface of the static mixer and obtaining an output stream comprising a product of a reaction of the at least first reactant in which the substance is extracted.

The various features and embodiments of the present invention, referred to in individual sections above apply, as appropriate, to other sections, mutatis mutandis. Consequently, features specified in one section may be combined with features specified in other sections as appropriate

Further embodiments of the above aspects are described below.

### BRIEF DESCRIPTION OF DRAWINGS

Preferred embodiments of the present disclosure will now be further described and illustrated, by way of example only, with reference to the accompanying drawings in which:

FIG. 1 is a visual representation of a surface grid of a reference mixer, according to an embodiment:

FIG. 2 is a visual representation of a surface grid of an example tree-like structure of a candidate static mixer design, according to an embodiment:

FIG. 3 is a visual representation of a surface grid of a first example ribbon structure of a candidate static mixer design, according to an embodiment;

FIG. 4 is a visual representation of a surface grid of a second example ribbon structure of a candidate static mixer design, according to an embodiment:

FIG. 5 is a visual representation of a surface grid of a third example ribbon structure of a candidate static mixer design, according to an embodiment:

FIG. 6 is a visual representation of a volume grid of the surface grid of FIG. 1, according to an embodiment:

FIG. 7 is a visual representation of a volume grid of the surface grid of FIG. 2, according to an embodiment:

FIG. 8 is a visual representation of a volume grid of the surface grid of FIG. 3, according to an embodiment:

FIG. 9 is a visual representation of a volume grid of the surface grid of FIG. 4, according to an embodiment:

FIG. 10 is a visual representation of a volume grid of the surface grid of FIG. 5, according to an embodiment:

FIG. 11 is a schematic representation of the electrochemical flow reactor, according to an embodiment:

FIG. 12 is a graph illustrating the chronoamperometric response of the experimentally evaluated static mixers in a electrochemical flow reactor, according to an embodiment; and

FIG. 13 is a graph illustrating the corresponding copper ion removal rate as determined by ICP-OES, for the static mixers featured in FIG. 12, according to an embodiment.

### DETAILED DESCRIPTION

The present disclosure describes the following various non-limiting embodiments, which relate to investigations undertaken to design and manufacture static mixers having an improved range of design complexity by implementing a design process based on numerical modelling, to understand the underlying flow physics, and artificial intelligence to guide users to new, hitherto unknown, solid geometries. It will be appreciated that the solid geometries may also include fenestrated geometries or porous geometries. It has surprisingly been found that with this advance in production of the design of static mixers, there is provided the option to explore unique and more complex static mixer designs to determine designs which improve performance over existing static mixer designs.

Further details and embodiments of the static mixers are described below.

### General Terms

In the following description, reference is made to the accompanying drawings which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more: reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, and processes, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B: item A, item B, and item C; or item B and item C. In some cases, “at least one of item A, item B, and item C” may mean, for example and without limitation, two of item A, one of item B, and ten of item C: four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Herein the term “about” encompasses a 10% tolerance in any value or values connected to the term.

### Specific Terms

“Element” refers to an individual unit that can be used together with one or more other components in forming a continuous flow reactor system. Examples of an element include an “insert” or “module” as described herein.

“Single pass reactor” refers to a reactor used in a process or system where the fluidic components pass through the reactor on a single occasion and are not recycled back through the reactor from which they have already passed through.

“Aspect ratio” means the ratio of length to diameter (L/d) of a single unit or element.

### Static Mixers

The present disclosure is directed to providing improvements in static mixer designs for fluid flow processes. The present disclosure covers various research and development directed to identifying and better understanding the designs of static mixers for a variety of industries such as industrial applications requiring mixing of emulsion, gasses, liquids or combinations thereof, chemical and bio-chemical synthesis, extraction processes, and polymer synthesis. Static mixers can also be converted to catalytic static mixers and used for reactions requiring catalysis or used as a monolith for a variety of applications including gas capture. It will be appreciated that projections may comprise a bio-inspired evolved architecture. In other words, the design of the static mixer element may be a blend of architecture and biomimetics/bioinspiration.

Traditionally, design improvement of static mixers has been led by a human designer's intuition, knowledge, experience, which may be supported by some numerical modelling. However, to test whether a new static mixer design performs well for a given application, the new static mixer may need to be manufactured, tested experimentally, and further re-design required until an optimal design is achieved for a particular application. One or more disadvantages associated with this traditional approach includes time and cost associated with manufacturing, experimentally testing each candidate static mixer design to identify a desirable design, and further re-design and manufacture of the static mixers. The time and cost often limits the extent of the design space that can be explored to identify a preferable static mixer design.

The inventors have found that the static mixers described herein designed, using an iterative computational workflow configured to determine an effective design for a static mixer, can provide enhanced performance for a specific flow application. The computational workflow comprises an evolutionary design (ED) algorithm configured to generate candidate static mixer designs, and a computational fluid dynamics (CFD) algorithm, configured to numerically evaluate the performance of the candidate static mixer designs for a specific application. The evolutionary design algorithm and the CFD algorithm operate iteratively to arrive at one or more static mixer designs that are expected to improve performance for the intended application.

As described further below, the static mixers can be configured as elements to provide inserts for use with in-line continuous flow reactor systems. The static mixers can also provide for the extraction of a substance (e.g. metal or mineral) from a fluid, such as a liquid or a gas.

It has been surprisingly found that the static mixers, at least according to some examples as described herein, in a particular application, can act as an adsorption site on which a particular substance of a fluid (gas and/or liquid) is adsorbed and then permanently extracted from the fluid phase, and can also demonstrate a degree of mixing. It will be appreciated that the efficiency of the static mixer device is dependent on how well the solid structure (i.e. scaffold) can capture dissolved substances in the fluid phase or can mix two or more liquids, gases or combinations thereof. Alternatively, efficiency can be dependent on a catalysis reaction when a static mixer is coated with a catalyst. Whilst the present disclosure describes one specific application as a proof-of-concept it will be understood that the static mixers described herein may also serve for a variety of applications.

The static mixer element as described herein may comprise an elongated integral scaffold, wherein the scaffold comprises a radially or axially arranged network or a spiral ribbon of polytope projections to define a plurality of passages configured for mixing one or more fluidic reactants during flow and reaction thereof through the mixer. The static mixer element as described herein may comprise an elongated integral scaffold, wherein the scaffold comprises a radially arranged network or a spiral ribbon of polytope projections to define a plurality of passages configured for mixing one or more fluidic reactants during flow and reaction thereof through the mixer. In an embodiment, the static mixer element may further include at least one elongated support member, wherein at least a portion of the projections are in connection with the elongated support element.

The static mixer element as described herein may comprise an elongated integral scaffold, wherein the scaffold comprises a radially or axially arranged network or a spiral ribbon of polytope projections to define a plurality of passages configured for mixing one or more fluidic reactants during flow and reaction thereof through the mixer, and at least one elongated support member, wherein at least a portion of the projections are in connection with the elongated support element. The static mixer element as described herein may comprise an elongated integral scaffold, wherein the scaffold comprises a radially arranged network or a spiral ribbon of polytope projections to define a plurality of passages configured for mixing one or more fluidic reactants during flow and reaction thereof through the mixer, and at least one elongated support member, wherein at least a portion of the projections are in connection with the elongated support element.

In some embodiments, the projections may extend radially or axially to form an outer perimeter of the static mixer element. In some embodiments, the projections may extend radially to form an outer perimeter of the static mixer element. In some embodiments, the projections may form a continuous network of passages arranged in multiple orientations relative to one another. It will be appreciated that non-continuous network arrangements of structures may also be formed. For example, not all designs will have a repetitious or networked (by geometry) structural motif.

The projections may be polytope structures repeated periodically or non-periodically along the longitudinal axis of the elongated support member. In a particular embodiment, the projections may be polytope structures repeated periodically along the longitudinal axis of the elongated support member. In some embodiments, the projections are the same polytope structures or are selected from at least two different types of polytope structures.

### Ribbon Mixers

The static mixer element as described herein may comprise an elongated integral scaffold, wherein the scaffold comprises an interconnected network of spiral ribbons comprising projections of polytope structures that form a plurality of passages configured for mixing one or more fluidic reactants during flow and reaction thereof through the mixer, and optionally at least one elongated support member, wherein at least a portion of the projections are in connection with the elongated support element.

In some embodiments, the scaffold may comprise at least two spaced apart elongated support members that are structurally connected via the interconnected network of projections. The scaffold may comprise at least three spaced apart elongated support members. For example, the scaffold may comprise at least four spaced apart elongated support members.

The elongated support member when present, is positioned in the same direction as the fluid flow while the ribbons spiral along the length of the support member from one end to the other to form the elongated scaffold. The projections on the ribbons are positioned to intersect the fluid flow and promote mixing of fluid through the scaffold. Alternatively, the projections are positioned to contact fluid through the mixture such that a component of the fluid will be adsorbed onto at least a portion of a projection.

### Tree-Shaped Mixers

The static mixer element as described herein may comprise a static mixer element comprising an elongated integral scaffold, wherein the scaffold comprises two or more sets of projections, wherein each set of projections are spaced apart from each other and extend radially or axially from a centrally located elongated support member to define a plurality of passages configured for mixing one or more fluidic reactants during flow and reaction thereof through the mixer. The static mixer element as described herein may comprise a static mixer element comprising an elongated integral scaffold, wherein the scaffold comprises two or more sets of projections, wherein each set of projections are spaced apart from each other and extend radially from a centrally located elongated support member to define a plurality of passages configured for mixing one or more fluidic reactants during flow and reaction thereof through the mixer. In some embodiments, the projections extend radially or axially to form an outer perimeter of the static mixer element. In some embodiments, the projections extend radially to form an outer perimeter of the static mixer element. The elongated support member when present, is positioned in the same direction as the fluid flow while the sets of projections are positioned along the length of the support member forming a tree shaped mixer with branches. The sets of projections are positioned to intersect the fluid flow and promote mixing of fluid through the scaffold. Alternatively, the projections are positioned to contact fluid through the mixture such that a component of the fluid will be adsorbed onto at least a portion of a projection.

### Projections

In some embodiments, the projections may extend radially or axially from the elongated support members to form an outer perimeter of the element. In some embodiments, the projections may extend radially from the elongated support members to form an outer perimeter of the element.

In some embodiments, the projections may be a polytope structure. As described herein, a polytope structure may be defined as a polygon or a polyhedron. The projections may be polytope structures repeated periodically or non-periodically along the longitudinal axis of the elongated support member. In a particular embodiment, the projections may be polytope structures repeated periodically along the longitudinal axis of the elongated support member. In some embodiments, the projections are the same polytope structures or are selected from at least two different types of polytope structures.

In some embodiments, the projections may be a polytope structure. As described herein, a polytope structure may be defined as a polygon or a polyhedron.

In some embodiments, the polytope structure may be a polygonal or polyhedral structure. In some embodiments, the polytope structure may be a regular or irregular triangular shaped polytope, preferably an irregular shaped polytope. In some embodiments, the polytope structure may be a scalene triangle, isosceles triangle, or equilateral triangle, preferably the polytope structure is a scalene or isosceles triangle.

In some embodiments, the polytope structure may be a 2-dimensional polygon structure or a 3-dimensional polyhedron structure. The 3-dimensional polyhedron structure may comprise triangular prisms, square based pyramids or triangle based pyramids.

In some embodiments, the projections may be connected to each other via at least a portion of at least one surface of a projection to form a continuous interconnected network of projections. In some embodiments, the projections may be connected to each other via at least a portion of at least one surface of a projection to form a continuous interconnected network of projections, wherein at least a portion of the interconnected network of projections are structurally connected to at least one elongated support member. In some embodiments, the projections may be connected to each other via at least a portion of at least one surface of a projection to form a continuous interconnected network of projections, wherein at least a portion of the interconnected network of projections are structurally connected to at least two elongated support members, preferably at least three elongated projections, even more preferably at least four elongated support members.

It will be appreciated that a polygon is a 2-dimensional polytope. A polygon is a plane figure that is described by a finite number of straight line or curved line segments connected to form a closed polygonal chain (or polygonal circuit). The bounded plane region, the bounding circuit, or the two together, may be called a polygon. The segments of a polygonal circuit are called its edges or sides. The points where two edges meet are the polygon's vertices (singular: vertex) or corners. The interior of a solid polygon is sometimes called its body. An n-gon is a polygon with n sides: for example, a triangle is a 3-gon. It will be appreciated that a polygon may also include a digon. A digon is a polygon with two sides (edges) and two vertices, wherein the two sides are curved. Polygons may be characterized by their convexity or type of non-convexity. For example, a convex polygon may be a polygon having any line drawn through the polygon (and not tangent to an edge or corner) meets its boundary exactly twice. As a consequence, all its interior angles are less than 180°. Equivalently, any line segment with endpoints on the boundary passes through only interior points between its endpoints. This condition is true for polygons in any geometry. A non-convex polygon may be a polygon having a line that may be found which meets its boundary more than twice. Equivalently, there exists a line segment between two boundary points that passes outside the polygon. A simple polygon may be a polygon where the boundary of the polygon does not cross itself. For example, all convex polygons are simple. A concave polygon is a non-convex and simple polygon. There is at least one interior angle greater than 180°. A star-shaped polygon may be the whole interior which is visible from at least one point, without crossing any edge. The polygon must be simple, and may be convex or concave. For example, all convex polygons are star-shaped. A self-intersecting polygon may be a polygon where the boundary of the polygon crosses itself. A star polygon may be a polygon which self-intersects in a regular way. A polygon cannot be both a star and star-shaped.

Polygons may be equiangular, equilateral, regular, cyclic, tangential, isogonal, or isogonal. An equiangular polygon may include a polygon where all corner angles are equal. An equilateral polygon may include a polygon where all edges are of the same length. A regular polygon may include a polygon having both equilateral and equiangular sides. A cyclic polygon may include a polygon having all corners lie on a single circle, called the circumcircle. A tangential polygon may include a polygon having all sides tangent to an inscribed circle. An isogonal or vertex-transitive polygon may include a polygon having all corners lie within the same symmetry orbit. The polygon may also be cyclic and equiangular. An isotoxal or edge-transitive polygon may include a polygon having all sides lie within the same symmetry orbit. The polygon may also be equilateral and tangential.

Any polygon has as many corners as it has sides. Each corner has several angles. The area of a polygon is defined as the area that is enclosed by the boundary of the polygon. In other words, the region that is occupied by any polygon gives its area. As polygons are closed plane shapes, thus, the area of a polygon is the space that is occupied by it in a two-dimensional plane. The unit of the area of any polygon is always expressed in square units.

It will be appreciated that a polyhedron is a 3-dimensional polytope. A polyhedron is a three-dimensional shape with flat polygonal faces, straight edges and sharp corners or vertices. A convex polyhedron is the convex hull of finitely many points, not all on the same plane. Cubes, triangular prisms, square based pyramids or triangle based pyramids are examples of convex polyhedral. Polyhedral solids have an associated quantity called volume that measures how much space they occupy. Simple families of solids may have simple formulas for their volumes; for example, the volumes of pyramids and prisms can easily be expressed in terms of their edge lengths or other coordinates.

In some embodiments, the polytope structure may be a polygonal or polyhedral structure. In some embodiments, the polytope structure may be a regular or irregular triangular shaped polytope, preferably an irregular shaped polytope. In some embodiments, the polytope structure may be a scalene triangle, isosceles triangle, or equilateral triangle, preferably the polytope structure is a scalene or isosceles triangle.

In some embodiments, the polytope structure may be a 2-dimensional polygon structure or a 3-dimensional polyhedron structure. The 3-dimensional polyhedron structure may comprise triangular prisms, square based pyramids or triangle based pyramids.

In some embodiments, the projections may be connected to each other via at least a portion of at least one surface of a projection to form a continuous interconnected network of projections. In some embodiments, the projections may be connected to each other via at least a portion of at least one surface of a projection to form a continuous interconnected network of projections, wherein at least a portion of the interconnected network of projections are structurally connected to at least one elongated support member. In some embodiments, the projections may be connected to each other via at least a portion of at least one surface of a projection to form a continuous interconnected network of projections, wherein at least a portion of the interconnected network of projections are structurally connected to at least two elongated support members, preferably at least three elongated projections, even more preferably at least four elongated support members.

In some embodiments, the projections may be structurally connected at an angle of less than about 90°.

In some embodiments, the scaffold may comprise two or more sets of projections, wherein each set of projections are spaced apart from each other and extend radially or axially from a centrally located elongated support member. In some embodiments, the scaffold may comprise two or more sets of projections, wherein each set of projections are spaced apart from each other and extend radially from a centrally located elongated support member. In some embodiments, each set of projections may be repeated periodically or non-periodically along the longitudinal axis of the elongated support member. In a particular embodiment, each set of projections may be repeated periodically along the longitudinal axis of the elongated support member. Each set of projections may comprise a polytope structure. In some embodiments, the polytope structure may be an elongated polyhedron structure. The elongated polyhedron structure may be cylindrical structure or a cone structure. In some embodiments, the cylindrical structure may be a branched cylindrical structure. The branched cylindrical structure may comprise one or more further projections from a first cylindrical structure. For example, the further projections may also be a cylindrical structure. It will be appreciated that the further projections may be the same or smaller in diameter and length when compared to the first cylindrical structure. In some embodiments, the projections may comprise fractal patterns. For example, the branched cylindrical structure may comprise one or more further projections from a first cylindrical structure, wherein the branched cylindrical structure may exhibit fractal patterns. In one example, the projections may be tree-shaped.

In some embodiments, the projections may be stepped projections. It will be appreciated that the stepped projections may also be referred to as grid or grid-like projections.

In some embodiments, the number of projections per set of projections may be in a range between about 1 and about 2000. The number of projections per set of projections may be at least about 1, 5, 10, 15, 20, 30, 40, 50, 60, 70, 80, 90, 100, 150, 200, 500, 1000, 1500, or 2000. The number of projections per set of projections may be less than about 2000, 1500, 1000, 500, 200, 150, 100, 90, 80, 70, 60, 50, 40, 30, 20, 10, 5, or 1. Combinations of these values to form various ranges are also possible, for example the number of projections per set of projections may be in a range between about 2 and about 1500, about 5 and about 1000, for example about 10 and about 500.

In some embodiments, the density of the projections may be in a range between about 1 projection per mm to about 50 projections per mm². The density of the projections (per mm²) may be at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50. The density of the projections (per mm²) may be less than about 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1. Combinations of these values to form various ranges are also possible, for example the density of the projections may be in a range between about 1 projection per mm² to about 20 projections per mm², about 1 projection per mm² to about 10 projections per mm², about 1 projections per mm² and about 8 projections per mm², for example about 1 projection per mm² to about 5 projections per mm².

In some embodiments, each set of projections may be equally spaced apart from each other forming segments, wherein each segment comprises at least two sets of projections. Preferably, each segment may be equally spaced apart from each other.

### Elongated Support Member

In some embodiments, the elongated support member may be an elongated polygonal prism. It will be appreciated that an polygonal prism as described herein may consist of two identical and parallel polygonal bases. The bases are connected by flat faces forming a uniform cross-section. The polygonal prism has bases, lateral faces, edges, and vertices. The base may be defined as having parallel faces which makes the two ends of any polygonal prism. They are congruent. The base determines the cross-section of any polygonal prism and it typically remains uniform throughout the shape. The lateral face may be defined as the non-parallel faces which connect the two bases. The vertices may be defined as the corners. The edges may be defined as where any two faces meet. Depending on the base, the polygonal prism can be of different shapes. In some embodiments, the geometry of the polygonal prism may be selected from any one or more of: cylindrical, triangular, rectangular, square, pentagonal, hexagonal, heptagonal, octagonal, nonagonal, decagonal, hendecagonal, dodecagonal, tridecagonal, tetradecagonal, and trapezoidal. In some embodiments, the polygonal prism may be regular or irregular based on the uniformity of its cross-section. A regular prism has a base which is a regular polygon with equal side lengths. Regular prisms have identical bases and identical lateral faces. An irregular prism has a base which is an irregular polygon with unequal side lengths. For example, an irregular prisms may have identical bases but the lateral faces are not identical. In one example, the elongated support member may be an elongated polygonal prism, wherein the polygonal prism is selected from cylindrical, triangular, rectangular, square, pentagonal, hexagonal, heptagonal, or octagonal. For example, the polygonal prism is selected from cylindrical, triangular, rectangular, square, pentagonal, or hexagonal. In a preferred example, the polygonal prism is selected from cylindrical, square, pentagonal, or hexagonal.

The elongated support member is designed to provide rigidity to the static mixer element. The elongated support member can be solid or hollow, or a combination of both. In some embodiments the elongated support member may be a solid elongated support member. In some embodiments the elongated support member may be a hollow elongated support member. The elongated support member may be located on any position of the static mixer element. If a single elongated support member is present, the elongated support member would preferably be at a central location. If more than one elongated support member is present, the elongated support members would preferably be equidistant from each other. Preferably, the elongated support members would be located toward the outer periphery of the static mixer.

### Geometry and Dimensions

In various embodiments, the geometry or configuration may be chosen to enhance one or more characteristics of the static mixer element selected from: the specific surface area, volume displacement ratio, line-of-sight accessibility for coating, strength and stability for high flow rates, suitability for fabrication using additive manufacturing, and to achieve one or more of: a high degree of chaotic advection, turbulent mixing, chemical and bio-chemical synthesis, extraction processes, polymer synthesis, catalytic interactions, and heat transfer.

In some embodiments, the scaffold may be configured to enhance chaotic advection or turbulent mixing, for example cross-sectional, transverse (to the net flow) or localised turbulent mixing. The geometry of the scaffold may be configured to change the localised flow direction or to split the flow more than a certain number of times within a given length along a longitudinal axis of the static mixer element, such as more than 200 per m⁻¹, optionally more than 400 per m⁻¹, optionally more than 800 per m⁻¹, optionally more than 1500 per m⁻¹, optionally more than 2000 per m⁻¹, optionally more than 2500 per m⁻¹, optionally more than 3000 per m⁻¹, optionally more than 5000 per m⁻¹. The geometry or configuration of the scaffold may comprise more than a certain number of flow splitting structures within a given volume of the static mixer, such as more than 100 per m⁻³, optionally more than 1000 per m⁻³, optionally more than 1×10⁴ per m⁻³, optionally more than 1×10⁶ per m⁻³, optionally more than 1×10⁹ per m⁻³, optionally more than 1×10¹⁰ per m⁻³.

The dimensions of the static mixer may be varied depending on the application. The static mixer, or reactor comprising the static mixer, may be tubular. The static mixer or reactor tube may, for example, have a diameter (in mm) in the range of 1 to 5000, 2 to 2500, 3 to 1000, 4 to 500, 5 to 150, or 10 to 100. The static mixer or reactor tube may, for example, have a diameter (in mm) of at least about 1, 5, 10, 25, 50, 75, 100, 250, 500, or 1000. The static mixer or reactor tube may, for example, have a diameter (in mm) of less than about 5000, 2500, 1000, 750, 500, 250, 200, 150, 100, 75, or 50. The aspect ratios (L/d) of the static mixer elements, or reactor chambers comprising the static mixer elements, may be provided in a range suitable for industrial scale flow rates for a particular reaction. The aspect ratios may, for example, be in the range of about 1 to 1000, 2 to 750, 3 to 500, 4 to 250, 5 to 100, or 10 to 50. The aspect ratios may, for example, be less than about 1000, 750, 500, 250, 200, 150, 100, 75, 50, 25, 20, 15, 10, 9, 8, 7, 6, 5, 4, 3, or 2. The aspect ratios may, for example, be greater than about 1, 2, 3, 4, 5, 6, 7, 8, 9, 10, 15, 20, 25, 50, 75, or 100. In one example, the aspect ratio (L/d) of each static mixer element can be at least 15. For example, the aspect ratio (L/d) of each static mixer element can be at least 25.

In some embodiments, the length (in mm) of the elongated support member may be in a range between 1 and 5000. The elongated support member may, for example, have a length (in mm) in the range of 1 to 5000, 2 to 2500, 3 to 1000, 4 to 500, 5 to 150, or 10 to 100. The elongated support member may, for example, have a length (in mm) of at least about 1, 5, 10, 25, 50, 75, 100, 250, 500, or 1000. The elongated support member may, for example, have a length (in mm) of less than about 5000, 2500, 1000, 750, 500, 250, 200, 150, 100, 75, or 50. Combinations of these upper and lower values to form various ranges are also possible.

In some embodiments, the diameter (in mm) of the elongated support member may be in a range between 1 and 5000. The elongated support member may, for example, have a diameter (in mm) in the range of 1 to 5000, 2 to 2500, 3 to 1000, 4 to 500, 5 to 150, or 10 to 100. The elongated support member may, for example, have a diameter (in mm) of at least about 1, 5, 10, 25, 50, 75, 100, 250, 500, or 1000. The elongated support member may, for example, have a diameter (in mm) of less than about 5000, 2500, 1000, 750, 500, 250, 200, 150, 100, 75, or 50. Combinations of these upper and lower values to form various ranges are also possible.

In some embodiments, the area (in m²) of the elongated support member may be in a range between 0.001 and 1000. The elongated support member may, for example, have an area (in m²) in the range of 0.001 to 1000, 0.002 to 500, 0.003 to 100, 0.004 to 50, 0.005 to 15, or 0.01 to 10. The elongated support member may, for example, have an area (in m²) of at least about 0.001, 0.005, 0.01, 0.025, 0.05, 0.075, 0.1, 0.25, 0.5, 1, 10, 20, 50, or 100. The elongated support member may, for example, have an area (in m²) of less than about 500, 250, 100, 75, 50, 25, 20, 15, 10, 7.5, or 5. Combinations of these upper and lower values to form various ranges are also possible.

In some embodiments, the length (in mm) of the projections may be in a range between 1 and 500. The projections may, for example, have a length (in mm) in the range of 1 to 500, 2 to 250, 3 to 100, 4 to 50, or 5 to 15. The projections may, for example, have a length (in mm) of at least about 1, 5, 10, 25, 50, 75, 100, 250, or 500. The projections may, for example, have a length (in mm) of less than about 500, 250, 100, 75, 50, 25, 20, 15, 10, 7.5, or 5. Combinations of these upper and lower values to form various ranges are also possible.

In some embodiments, the diameter (in mm) of the projections may be in a range between 1 and 50. The projections may, for example, have a diameter (in mm) in the range of 1 to 50, 2 to 40, 3 to 30, 4 to 20, or 5 to 10. The projections may, for example, have a diameter (in mm) of at least about 1, 2, 3, 4, 5, 10, 15, 20, 25, 30, 35, 40, or 50. The projections may, for example, have a diameter (in mm) of less than about 50, 25, 10, 7.5, 5, 2.5, 2, or 1. Combinations of these upper and lower values to form various ranges are also possible.

In some embodiments, the area (in m²) of the projections may be in a range between 0.001 and 1. The projections may, for example, have an area (in m²) in the range of 0.001 to 1, 0.002 to 0.5, 0.003 to 0.1, 0.004 to 0.05, or 0.005 to 0.015. The projections may, for example, have an area (in m²) of at least about 0.001, 0.005, 0.01, 0.025, 0.05, 0.075, 0.1, 0.25, 0.5, or 1. The elongated support member may, for example, have an area (in m²) of less than about 1, 0.5, 0.2, 0.1, 0.05, 0.02, 0.01, 0.005, 0.002, or 0.001. Combinations of these upper and lower values to form various ranges are also possible

The static mixer element or reactor is generally provided with a high specific surface area (i.e., the ratio between the internal surface area and the volume of the static mixer element and reactor chamber). The specific surface area may be lower than that provided by a packed bed reactor system. The specific surface area (m² m⁻³) may be in the range of 100 to 40,000, 200 to 30,000, 300 to 20,000, 500 to 15,000, or 12000 to 10,000. The specific surface area (m² m⁻³) may be at least 100, 200, 300, 400, 500, 750, 1000, 2000, 3000, 4000, 5000, 7500, 10000, 12500, 15000, 17500, or 20000. It will be appreciated that the specific surface areas can be measured by a number of techniques including the BET isotherm techniques.

The static mixer elements may be configured for enhancing properties, such as mixing and heat transfer, for laminar flow rates or turbulent flow rates. It will be appreciated that for Newtonian fluids flowing in a hollow pipe, the correlation of laminar and turbulent flows with Reynolds number (Re) values would typically provide laminar flow rates where Re is <2300, transient where 2300<Re<4000, and generally turbulent where Re is >4000. The static mixer elements may be configured for laminar or turbulent flow rates to provide enhanced properties selected from one or more of mixing, degree of reaction, heat transfer, and pressure drop. It will be appreciated that further enhancing a particular type of chemical reaction will require its own specific considerations.

In one embodiment, the static mixer element may be generally configured for operating at a Re of at least 0.01, 0.1, 1, 5, 50, 100, 150, 200, 250, 300, 350, 400, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, 8000, 8500, 9000, 9500, 10000. The static mixer element may be configured for operating in a generally laminar flow Re range of about 0.1 to 2000, 1 to 1000, 10 to 800, or 20 to 500. The static mixer element may be configured for operating in a generally turbulent flow Re ranges of about 1000 to 15000, 1500 to 10000, 2000 to 8000, or 2500 to 6000.

The volume displacement % of the static mixer relative to a reactor chamber for containing the mixer is in the range of 1 to 40, 2 to 35, 3 to 30, 4 to 25, 5 to 20, or 10 to 15. The volume displacement % of the static mixer relative to a reactor chamber for containing the mixer may be less than 40%, 35%, 30%, 25%, 20%, 15%, 10%, or 5%.

In another embodiment, the volume displacement % of the static mixer relative to a reactor chamber for containing the mixer may be in the range of 20 to 70%, 25 to 70%, 23 to 70%, 25 to 65%, 23 to 50%, 25 to 55%, 20 to 50%, 30 to 60%, 35 to 55%, 40 to 70%, 40% to 60%, 40% to 55%, or 40% to 50%. The volume displacement % of the static mixer relative to a reactor chamber for containing the mixer may be less than 70%, 65%, 60%, 55%, 50%, 45%, 40%, 35%, 30%, 25%, 23%, or 20%. The volume displacement % of the static mixer relative to a reactor chamber for containing the mixer may be at least 20%, 23%, 25%, 30%, 35%, 40%, 40%, 45%, 50%, 55%, 60%, 65%, or 70%. The volume displacement % of the static mixer relative to a reactor chamber for containing the mixer may be a range provided by any two of these upper and/or lower values.

The configurations of the static mixers may be provided to enhance cross-sectional microscopic turbulence. Such turbulence may result from various sources, including the geometry of static mixer or the microscopic roughness of the static mixer surface resulting from the manufacturing process and/or surface coating. For example, turbulent length scales may be reduced to provide better mixing. The turbulent length scales may, for example, be in the range of microscopic length scales.

The configurations of the static mixers may be provided to enhance heat transfer properties in the reactor, for example a reduced temperature differential at the exit cross-section. The heat transfer of the static mixer may, for example, provide a cross-sectional or transverse temperature profile that has a temperature differential of less than about 20° C./mm, 15° C./mm, 10° C./mm, 9° C./mm, 8° C./mm, 7° C./mm, 6° C./mm, 5° C./mm, 4° C./mm, 3° C./mm, 2° C./mm, or 1° C./mm.

The scaffold may be configured such that, in use, the pressure drop (i.e. pressure differential or back pressure) across the static mixers (in Pa/m) is in a range of about 0.1 to 1,000,000 Pa/m (or 1 MPa/m), including at any value or range of any values therebetween. For example, the pressure drop across the static mixer (in Pa/m) may be less than about 500,000, 250,000, 100,000, 50,000, 10,000, 5,000, 1,000, 750, 500, 250, 100, 75, 50, 25, 20, 15, 10, or 5 Pa/m. The static mixers may be configured to provide a lower pressure drop relative to a specific flow rate. In this regard, the static mixers, reactor, system, and processes, as described herein, may be provided with parameters suitable for industrial application. The above pressure drops may be maintained where the volumetric flow rate is at least 0.1, 0.5, 1, 1.5, 2, 2.5, 3, 3.5, 4, 4.5, 5, 6, 7, 8, 9, 10, 20, 30, 40, 50 ml/min.

### Scaffold

In some embodiments, the scaffold may comprises or consist of a metal, metal alloy, metal oxide, ceramic, cermet, composites, polymers, glasses, natural products, or combinations or derivatives thereof. The scaffold may be a metal scaffold, for example formed from metals or metal alloys. The scaffold may be formed from a metal or metal alloy capable of catalytic reactions, such as platinum or palladium. The metal scaffold may be prepared from a material suitable for additive manufacturing (i.e. 3D printing). The metal scaffold may be prepared from a material suitable for further surface modification to provide or enhance catalytic reactivity, for example a metal including nickel, titanium, palladium, platinum, gold, copper, aluminium or their alloys and others, including metal alloys such as stainless steel. In one embodiment the metal for the scaffold may comprise or consist of titanium, stainless steel, and an alloy of cobalt and chromium. In another embodiment, the metal for the scaffold may comprise or consist of stainless steel and cobalt chromium alloy. The scaffold may comprise or consist of a metal selected from at least one of iron, aluminium, cobalt, copper, zinc, nickel, palladium, platinum, gold, silver, ruthenium, iridium, rhodium, titanium vanadium, zirconium, niobium, tantalum, and chromium, or a metal alloy, cermet or metal oxide thereof. The scaffold may comprise or consist of titanium, aluminium, nickel, iron, silver, cobalt, chromium, or an alloy thereof. The scaffold may comprise or consist of nickel which may be useful for flow production of biodiesel. The scaffold may comprise or consist of titanium, titanium alloy or stainless steel. The titanium alloy may comprise aluminium and vanadium, for example. Non-limiting examples of other transition metals that may be used in metal alloys are zirconium, niobium and tantalum. In an embodiment, the scaffold comprises at least one of a metal, semi-metal and metal oxide.

In some embodiments, at least a portion of a surface of the scaffold may comprise a coating, a gradient coating, a decorated coating (e.g. nanoparticles), a selectively patterned coating, or any combination thereof.

In some embodiments, the process of preparing a static mixer may comprise a step of applying a coating onto at least a substantial portion of the scaffold. For example, the coating may be provided on at least 50% of the surface of the scaffold. In other embodiments, the coating may be provided on at least 60%, 70%, 80%, 90%, 95%, 98, or 99%, of the surface of the scaffold.

In some embodiments, at least a portion of a surface of the scaffold may comprise a catalytic material for providing the surface with catalytically reactive sites. In some embodiments, the catalytically reactive sites are provided by at least one of: the scaffold being formed from a catalytic material: a catalyst material being intercalated, interspersed and/or embedded with at least part of the scaffold; and at least a part of the surface of the scaffold comprising a coating comprising a catalyst material. In particular, static mixers incorporating catalysts, generally referred to as catalytic static mixers or CSMs.

In an embodiment, the static mixers according to this invention or CSMs produced using the static mixers designed according to this invention may be coated using known electrochemical, chemical dipping, decoration, or any other techniques known in the art.

In some embodiments, the process of preparing a static mixer may comprise a step of applying a coating comprising the catalytic material onto at least a substantial portion of the scaffold. For example, the coating may be provided on at least 50% of the surface of the scaffold. In other embodiments, the coating may be provided on at least 60%, 70%, 80%, 90%, 95%, 98, or 99%, of the surface of the scaffold.

In some embodiments, the catalytic material may be coated onto the surface of the scaffold to form a catalytic layer. In some embodiments, the surface of the catalytic layer may have a high roughness. The high roughness may enhance micro-scale turbulent mixing of the fluidic reactants near the surface of the catalytic layer, and may provide a larger surface area of catalytic material on which catalytic reactions can occur. In some applications, it may be preferable to deposit the catalytic material on the scaffold in order to form a more porous catalytic layer, or a catalytic layer with high roughness.

### Continuous Flow Systems and Reactors

The present disclosure provides a continuous flow chemical reactor for use in catalytic reactions of one or more fluidic reactants. The reactor may comprise one or more chamber sections in fluid communication with each other. It will be appreciated that at least one chamber section comprises a static mixer element. The chamber sections may be referred to as chamber modules, wherein each module may contain one or more static mixer elements. The static mixer element can be configured for inserting into a continuous flow chemical reactor, which may be referred to as a “static mixer insert”. The static mixer elements or inserts may also be provided in the form of one or more modules. It will be appreciated that the static mixer is an integral part of the chemical reactor. The static mixer and chamber section together form the reactor chamber, which may be provided as a single unit. The chamber section may provide the housing for the static mixer. The chamber section may optionally include a heat exchanger system, which may be used for controlling heat removed from the reactor chamber during its operation. The chamber section may include a one or more static mixer elements, one or more catalytic static mixer elements, one or more heat exchanger systems, etc., and combinations thereof. The one or more static mixer elements or chamber sections may be configured for use in series or parallel operation. It will be appreciated that the static mixer, or reactor thereof, may comprise one or more reactant inlets for supply of one or more fluidic reactants to a chamber section, and one or more outlets in fluid communication with the static mixer for receiving an output stream comprising a product or products of the reaction.

In one embodiment, the continuous flow chemical reactor is a tubular or plug flow reactor.

In another embodiment, the reactor comprises a heat exchanger for controlling the temperature of the reactor, chamber section, static mixer (or catalytic static mixer), or fluidic components thereof. The heat exchanger may be a shell and tube heat exchanger design or configuration.

In an embodiment, the aspect ratios of the reactor may, for example, be similar to those previously described for the static mixer such that a static mixer element may be configured for insertion into the reactor. In one example, the aspect ratio (L/d) of the reactor can be at least about 50. In another example, the aspect ratio (L/d) of the reactor can be at least about 75. For example, the aspect ratio (L/d) of each static mixer element can be at least 15, and arranged in each reaction chamber section in a series of one or more static mixer elements to a total aspect ratio (L/d) of at least 50. In another example, the aspect ratio (L/d) of each static mixer element can be at least 25, and arranged in each reaction chamber section in a series of one or more static mixer elements to a total aspect ratio (L/d) of at least 75.

The present disclosure also provides a system for a continuous flow chemical reaction process comprising:
a continuous flow chemical reactor comprising one or more static mixers according to any of the embodiments described herein;
a pump for providing fluidic flow for one or more fluidic reactants and any products thereof through the reactor;
optionally one or more heat exchangers for controlling the temperature of the reactor, chamber section, static mixer, or fluidic components thereof; and
a control means for controlling one or more of the parameters of the system selected from concentration, flow rate, temperature, pressure, and residence time, of the one or more fluidic reactants, sources of fluidic reactants, carrier fluids, or products of the reaction.

In an embodiment, the static mixer may be a catalytic static mixer.

The system may further comprise a dispersing unit, which can be configured before and/or after the chamber section. The dispersing unit may comprise a static mixer for dispersing the one or more fluidic reactants.

The system may further comprise a spectrometer, which can be used for identifying and determining concentrations for any one or more fluidic reactants or products thereof.

One or more of the reactor, reactor chamber, chamber section and static mixer, may each be provided in modular form for complimentary association thereof. The system may comprise a plurality of reactors, which may be of similar or different internal and/or external configuration. The reactors may operate in series or in parallel. It will be appreciated that the system, reactor, or each chamber section, may include one or more inlets and outlets to provide supply of reactants, obtain products, or to recirculate various reactants and/or products.

It will also be appreciated that the reactor or system may be designed for recycling of the various reactants, reactant sources, intermediary products, or desired products provided to and produced in the chamber sections. The reactor or system may be provided in various designs and forms, for example in the form of a tubular reactor. In another embodiment, the reactor is a single pass reactor.

The system and processes may also be integrated into more complex systems, such as systems and processes comprising a coal gasifier, electrolyser and/or natural gas reformer etc.

Application Specific Designs e.g. Metal or Mineral Extraction

In one embodiment, for example, static mixers or CSMs may find applications in hydrogenation/dehydrogenation reactions in flow chemistry reactors, hydrogen generation, electrowinning, electroplating, electrochemical removal of heavy metal ions, reactions involving the mixing of poorly miscible fluids or fluids/gases, reactions involving supercritical fluids such as CO₂ which could be used as a reaction solvent, polymer synthesis via emulsions which require large shear rate and narrow residence time distribution, absorption (in addition to adsorption), sorbent applications, catalyst augmented photochemistry, polymerisation, and/or water splitting. In an embodiment, the static mixer may be used with an electrically conductive counter electrode tube such as ITO, FTO which could make the reactor transparent, allowing in-situ measurement of the reactor in operation. The static mixer element could be evolved to allow a co-axial inspection path for in-situ determination of reactor performance as part of a broader control or optimisation system. Optical methods may include FTIR, UV-Vis, Raman Spectroscopy of any known to those trained in the state of the art. Applications could also include methods to those trained in the state-of-the-art and would find general applicability in chemical engineering and chemistry applications.

The static mixer may be for use in a fluid flow system and process. The process may be an in-line continuous flow process. The in-line continuous flow process may be a recycle loop or a single pass process. In one embodiment, the in-line continuous flow process is a single pass process.

As mentioned above, the reactor comprising the static mixer element is capable of performing metal extraction reactions in a continuous fashion. The chemical reactor may use single or multi-phase feed and product streams. In one embodiment, the substrate feed (comprising one or more reactants) may be provided as a continuous fluidic stream, for example a liquid stream containing either: a) the substrate as a solute within an appropriate solvent, or b) a liquid substrate, with or without a co-solvent. The substrate feed is pumped into the reactor using pressure driven flow, e.g. by means of a piston pump.

The present disclosure also provides a process for extracting a substance from one or more fluidic reactants, the process comprising the steps of:
providing a continuous fluid flow reactor comprising a static mixer element or system according to any of the embodiments described herein;
providing at least a first fluidic reactant to the reactor via the one or more reactant inlets;
operating the reactor, or control means thereof, to provide flow and reaction of the at least first fluidic reactant through the static mixer; and
adsorption of a substance from the at least first reactant to at least a portion of the surface of the static mixer and obtaining an output stream comprising a product of a reaction of the at least first reactant in which the substance is extracted.

It will be appreciated that various parameters and conditions used in the process, such as temperatures, pressures and concentration/amounts of materials and reactants, may be selected depending on a range of variables of the process including the product to be synthesised, chemical reaction or mechanisms involved, reactant source, selection of a minerals(s) used, or type of reactor being used and materials and configuration thereof. For example, differences will exist where the one or more fluidic reactants, or co-solvents (e.g. inert carriers) etc., are gases, liquids, solids, or combinations thereof. For example, one or more fluidic reactants may be provided in a fluidic carrier, such as a solute reactant in liquid carrier. The one or more fluidic reactants may be provided as a liquid carrier comprising one or more dissolved minerals. For example, the liquid carrier may comprise one or more dissolved metals (e.g. copper or lithium).

An example application for the static mixers according to any of the embodiments described herein is the extraction of a dissolved heavy metal or mineral, such as copper or lithium, from a contaminated solution. The contaminated solution (liquid or gas) flows through a narrow, long tubular reactor which comprises an outer tube and an internal static mixer element. Physically as the fluid flows through the reactor, a chemical component is extracted by adsorption on the surface of the scaffold of the static mixer element.

Since adsorption occurs at the surface, it is desirable to maximise the surface area of the static mixer: however, maximising the surface area of the static mixer may have two consequences on the flow of fluid through the static mixer element. Firstly, if the surface area is increased, the solid's volume may also be increased, which results in a greater obstruction to fluid flow within the reactor. This can lead to, at worst, blockage of the tube or to a lesser extent curtail the flow. Secondly, the fluid should ideally mix and to be maximally dispersed to all regions of the static mixer element to result in a uniform adsorption onto the entire substrate. Accordingly, for this example application, it is desirable to arrive at a design for a static mixer element that optimises the two parameters of maximising surface area of the static mixer and maximising mixture and dispersion of the fluid. For other applications, there may be different or additional parameters to consider.

Temperatures (° C.) in relation to the process may be in a range between −50 and 400, or at any integer or range of any integers there between. For example, the temperature (° C.) may be at least about −50, −25, 0, 25, 50, 75, 100, 150, 200, 250, 300, or 350. For example, the temperature (° C.) may be less than about 350, 300, 250, 200, 150, 100, or 50. The temperature may also be provided at about any of these values or in a range between any of these values, such as a range between about 0 to 250° C., about 25 to 200° C., or about 50 to 150° C.

As previously mentioned with respect to the static mixer element, the process may involve operation at a Re of at least about 0.01, 0.1, 1, 5, 50, 100, 150, 200, 250, 300, 350, 400, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, 8000, 8500, 9000, 9500, or 10000. The process may involve operation at a Re range provided by any two of the previously recited values. The process may involve operation at a generally laminar flow, for example a Re range of about 50 to 2000, 100 to 1500, 150 to 1000, or 200 to 800. The process may involve operation at a generally turbulent flow, for example at a Re range of about 3000 to 15000, 4000 to 10000, or 5000 to 9000.

The volume displacement % of the static mixer relative to a reactor chamber for containing the mixer is in the range of 1 to 40, 2 to 35, 3 to 30, 4 to 25, 5 to 20, or 10 to 15. The volume displacement % of the static mixer relative to a reactor chamber for containing the mixer may be less than 40%, 35%, 30%, 25%, 20%, 15%, 10%, or 5%.

In another embodiment, the volume displacement % of the static mixer relative to a reactor chamber for containing the mixer may be in the range of 20 to 70%, 25 to 70%, 23 to 70%, 25 to 65%, 23 to 50%, 25 to 55%, 20 to 50%, 30 to 60%, 35 to 55%, 40 to 70%, 40% to 60%, 40% to 55%, or 40% to 50%. The volume displacement % of the static mixer relative to a reactor chamber for containing the mixer may be less than 70%, 65%, 60%, 55%, 50%, 45%, 40%, 35%, 30%, 25%, 23%, or 20%. The volume displacement % of the static mixer relative to a reactor chamber for containing the mixer may be at least 20%, 23%, 25%, 30%, 35%, 40%, 40%, 45%, 50%, 55%, 60%, 65%, or 70%. The volume displacement % of the static mixer relative to a reactor chamber for containing the mixer may be a range provided by any two of these upper and/or lower values.

Further advantages of the static mixers, at least according to some embodiments as disclosed herein, is provided by an increase in the volume displacement % of the static mixer element relative to a reaction chamber section for housing the static mixer element to a value of greater than 20%, e.g. greater than 23%, may provide a static mixer with enhanced performance in terms of a) total metal adsorption, and/or b) mixing performance.

The configurations of the static mixers may be provided to enhance cross-sectional microscopic turbulence. Such turbulence may result from various sources, including the geometry of the static mixers or the microscopic roughness of the static mixer surface resulting from the manufacturing process. For example, turbulent length scales may be reduced to provide better mixing. The turbulent length scales may, for example, be in the microscopic length scales.

The configurations of the static mixers may be provided to enhance heat transfer properties in the reactor, for example a reduced temperature differential at the exit cross-section. The heat transfer of the static mixer may, for example, provide a cross-sectional or transverse temperature profile that has a temperature differential of less than about 20° C./mm, 15° C./mm, 10° C./mm, 9° C./mm, 8° C./mm, 7° C./mm, 6° C./mm, 5° C./mm, 4° C./mm, 3° C./mm, 2° C./mm, or 1° C./mm.

The scaffold may be configured such that, in use, the pressure drop (or back pressure) across the static mixers (in Pa/m) is in a range of about 0.1 to 1,000,000 Pa/m (or 1 MPa/m), including at any value or range of any values therebetween. For example, the pressure drop (or back pressure) across the static mixer (in Pa/m) may be less than about 500,000, 250,000, 100,000, 50,000, 10,000, 5,000, 1,000, 750, 500, 250, 100, 75, 50, 25, 20, 15, 10, or 5 Pa/m. The static mixers may be configured to provide a lower pressure drop relative to a specific flow rate. In this regard, the static mixers, reactor, system, and processes, as described herein, may be provided with parameters suitable for industrial application. The above pressure drops may be maintained where the volumetric flow rate is at least 0.1, 0.5, 1, 1.5, 2, 2.5, 3, 3.5, 4, 4.5, 5, 6, 7, 8, 9, 10, 20, 30, 40, 50, 100, 500, 1000 ml/min.

The process may involve a mean residence time in the static mixer or reactor in a range of about 1 second to about 5 hours. The mean residence time (in minutes) may, for example, be less than about 300, 250, 200, 150, 120, 100, 80, 60, 45, 30, 15, 10, 9, 8, 7, 6, 5, 4, 3, 2, 1, 0.5 or 0.1. The mean residence time (in minutes) may, for example, be greater than about 0.1, 0.5, 1, 2, 3, 4, 5, 6, 7, 8, 9, 10, 15, 30, 45, 60, 80, 100, 120, 150, 200, or 250. The mean residence time may be provided as a range selected from any two of these previously mentioned values. For example, the mean residence time may be in a range of 2 to 10, 3 to 8, 4 to 7, or 5 to 6 minutes.

The process may provide a metal adsorption rate (% metal extracted from reactant) of at least 5, 10, 15, 20, 25, 30, 35, 40, 45, 50, 55, 60, 65, 70, 75, 80, 85, 90, 95, 98, 99, 99.5, 99.9%.

### Design Process

Provided herein is an iterative computational workflow that is configured to determine a design for a static mixer that will perform well for an intended flow application.

The computational workflow comprises an evolutionary design (ED) algorithm configured to generate candidate static mixer element designs, and a computational fluid dynamics (CFD) algorithm, configured to numerically evaluate the performance of the candidate static mixer element designs for a specific application. The evolutionary design algorithm and the CFD algorithm operate iteratively to arrive at one or more well performing static mixer element designs.

With similarities to natural evolution, the computational workflow is based on iterations over multiple, successive generations with each generation comprising of multiple children. In one embodiment, one or more initial designs (parent designs) are input to the ED module. Over many generations, the improvement in fitness values converge until a threshold is met and the computational workflow outputs the best performing static mixer design(s).

In one embodiment, the computational workflow designs a static mixer element for a specific application. In one embodiment, the computational workflow designs a static mixer element for the decontamination of a heavy metal solution. For example, in this particular application the static mixer element may be referred to as a metallic electrode and the continuous flow chemical reactor chamber may be referred to as an outer cylindrical metal casing. In which case, a heavy metal solution may be decontaminated by passing the solution through an electrochemical cell (e.g. a reactor) consisting of an inner, solid, metallic electrode (e.g. a static mixer element) and an outer cylindrical metal casing or positive electrode (e.g. reactor chamber).

The contaminated solution needs to come in contact with the inner metallic mixer electrode, where upon heavy metal ions come into contact with the inner electrode at which point the heavy metal ions are extracted out of solution with an associated current from inner to outer electrode. It is desirable to make the electrochemical cell as efficient as possible and thus maximise the heavy metal extraction rate. In one embodiment, to improve the heavy metal extraction rate, the shape of the inner electrode may be modified such that the inner mixer electrode fits within the cylindrical casing. The main criteria for selecting the shape of the inner electrode are (i) maximal substrate adsorption and (ii) the electrode must not impede the flow or cause stagnant regions of flow and allow mixing of the fluid with all parts of the inner electrode. These two criteria oppose each other since increasing substrate adsorption is related to the substrate surface area and increasing surface area generally also increases volume of solid which will tend to impede the flow.

A process for design and manufacture of a static mixer element for a continuous flow chemical reactor chamber may comprise the steps of:
designing a static mixer element, as described by any one or more embodiments herein, comprising a scaffold defining a plurality of passages configured for mixing one or more fluidic reactants during flow and reaction thereof through the mixer using evolutionary design;
additive manufacturing the static mixer element;
optionally applying a catalytic coating to the surface of the scaffold of the prototype static mixer element to form a catalytic static mixer (CSM) element.

The static mixer and optional catalytic coating may be provided by any embodiments thereof as described herein. The manufacturing of the static mixer element may be by various methods known in the art, for example additive manufacture.

As described herein, the design process may be based on Evolutionary Design (ED), which are population-based, iterative optimisers. It will be appreciated that EDs are particularly suited for optimisation because they can efficiently explore vast regions of a complex design space and generate a diverse range of useful solutions. The inputs to these algorithms are fitness objectives which, when evaluated, yield quantitative measures for the features which need to be optimised for each design modelled. The fitness values may be optimised by iteration. Changes to the static mixer shape may be controlled by EDs that respond to not just changes to the fitness values, but also to how fast the fitness values are changing. It will be appreciated that the ED as described herein may create a population of individuals with geometries that can perform better as static mixers than their previous generation. It has two major parts: (i) Evolution Algorithm (EA), which involves the genotype and performance index of the individuals in a generation as input and produces the genotype of the individuals in the next generation; and (ii) Shape Generator (SG), where the genotype from EA can be expressed into mixer geometry as its phenotype. The performance of a particular geometry in a certain fluid mixing environment can then be evaluated with computational fluid dynamics (CFD), i.e. this may provide a performance index. In combination, EA and SG “design” geometries can provide increasingly better static mixer elements, one generation at a time. The “genes” communicated between EA and SG take the form of a set of real number between (and including) zero and one. The size of the set varies with the type of geometry.

The operation of the coupled workflow may be computationally expensive. Accordingly, in one embodiment, the workflow is parallelized to run on multiple central processing units (CPUs), concurrently. In one embodiment, the workflow is implemented on High-Performance Computer (HPC) clusters (NCI Gadi and Pawsey) so as to maximize the number of different computer experiments that can be run and also the number of different families of geometries that can be tested.

Computational fluid dynamics (CFD) software can be used in the design to obtain various enhanced configurations of the static mixer, which will be determined by the desired applications.

The geometry may be chosen and optimised to enhance various characteristics of the static mixer element, such as the specific surface area, volume displacement ratio, line-of-sight accessibility for coating, strength and stability for high flow rates, suitability for fabrication using additive manufacturing, or to achieve a high degree of chaotic advection, turbulent mixing, or heat transfer. These characteristics, as well as any other characteristics of interest, may be weighted based on their relative importance to a particular application, and the design optimisation process can be directed towards enhancing the characteristics which are given more weight.

It will be appreciated that mixing refers to the process by which two (or more) separate constituents of the flow (i.e. different chemical species or scalar constituents with different values, e.g. temperature) are brought together eventually and interact at a molecular level. Consider tracer transport in laminar and turbulent flows. This can be represented by straight, parallel streamlines, which are parallel to the mean flow. In laminar flow the fluid particles follow the streamlines exactly, which can as shown by a linear dye trace in a laminar region. In turbulent flow eddies of many sizes are superimposed onto the mean flow. When dye enters the turbulent region it traces a path dictated by both the mean flow (streamlines) and eddies. Larger eddies carry the dye laterally across streamlines. Smaller eddies create smaller scale stirring that causes the dye filament to spread (diffuse). It is the diffusion that creates the local mixing of constituents that are transported to various locations by larger eddies.

The description of turbulence uses at least two quantities: 1. the intensity of turbulence indicated by the “turbulent kinetic energy” in the turbulent fluctuations, and 2. the scale around which this energy is concentrated, represented by the peak in the turbulence spectrum, or equivalently the “turbulence length scale”. A flow with a higher turbulent kinetic energy would therefore involve more vigorous mixing whilst a flow with a higher turbulent length scale would indicate that mixing occurs across a wider region.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLES

The present disclosure is further described by the following examples. It is to be understood that the following description is for the purpose of describing particular embodiments only and is not intended to be limiting with respect to the above description.

### Example 1 Copper Extraction

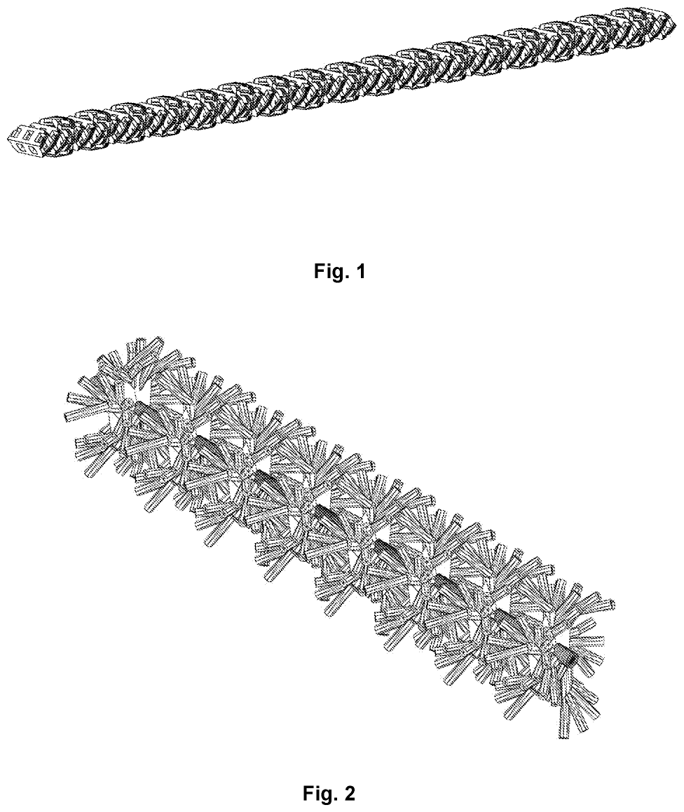

The inventors performed an experimental procedure to determine the performance of the preferred static mixer designs described herein. The experimental procedure comprised an electrochemical experiment which extracted copper from a contaminated solution. It will be appreciated that an equivalent process can be used for lithium extraction when used during recycling of lithium batteries. The results of this experiment were compared with the results of a similar experiment which utilised an existing prior art static mixer (FIG. 1) which was found to completely decontaminate a solution within 24 hours.

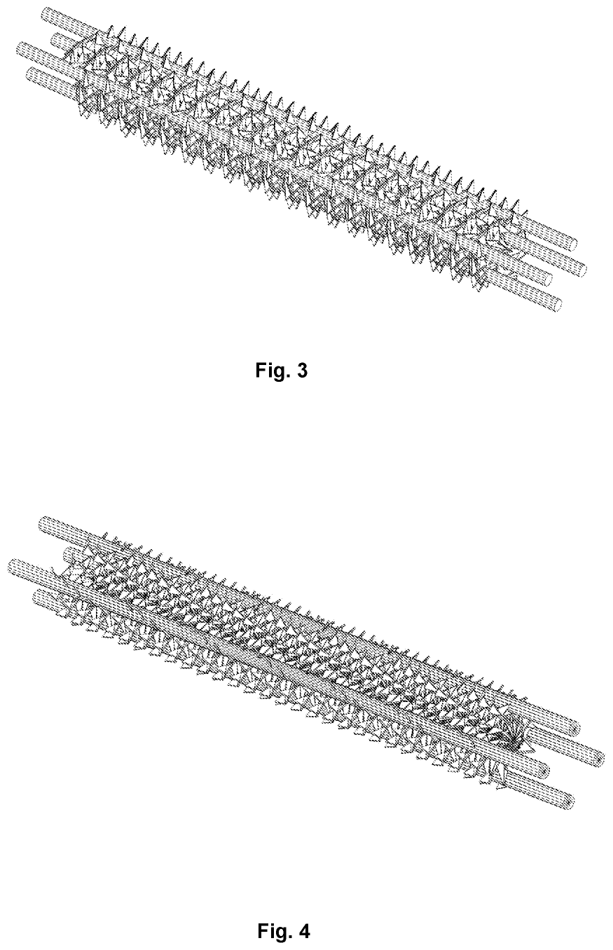

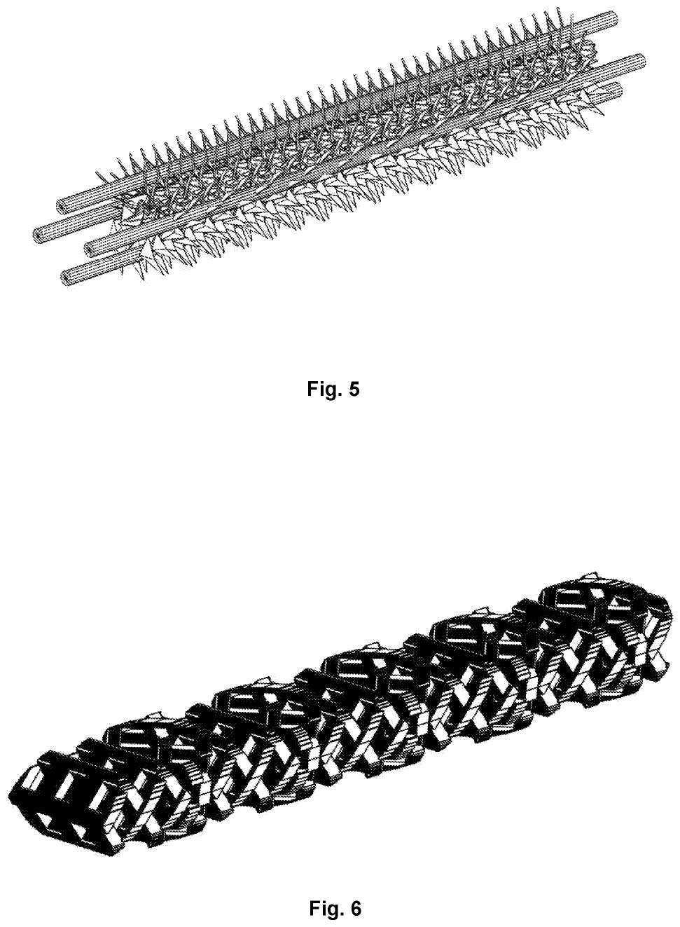

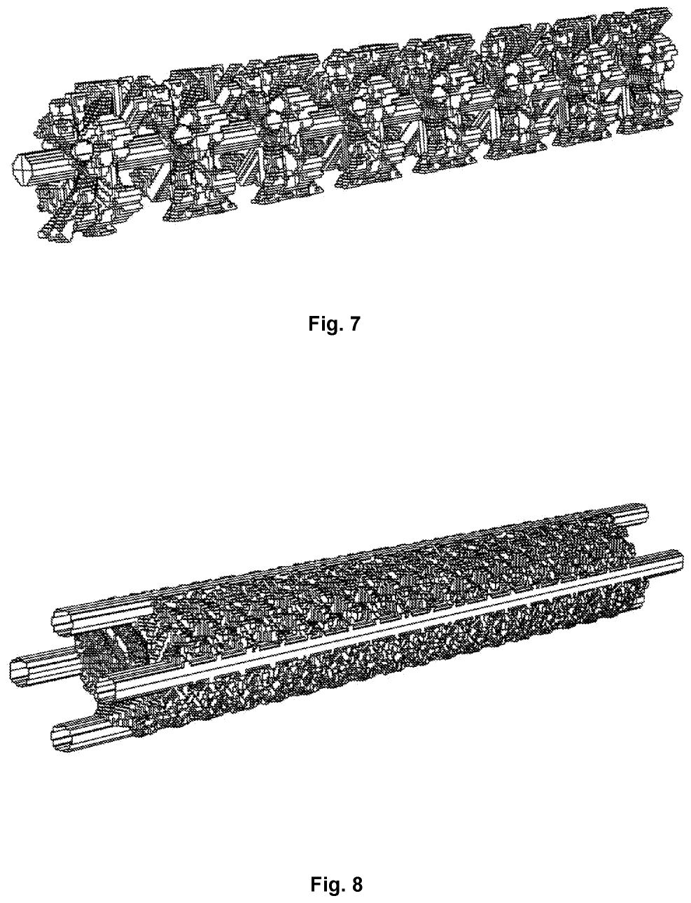

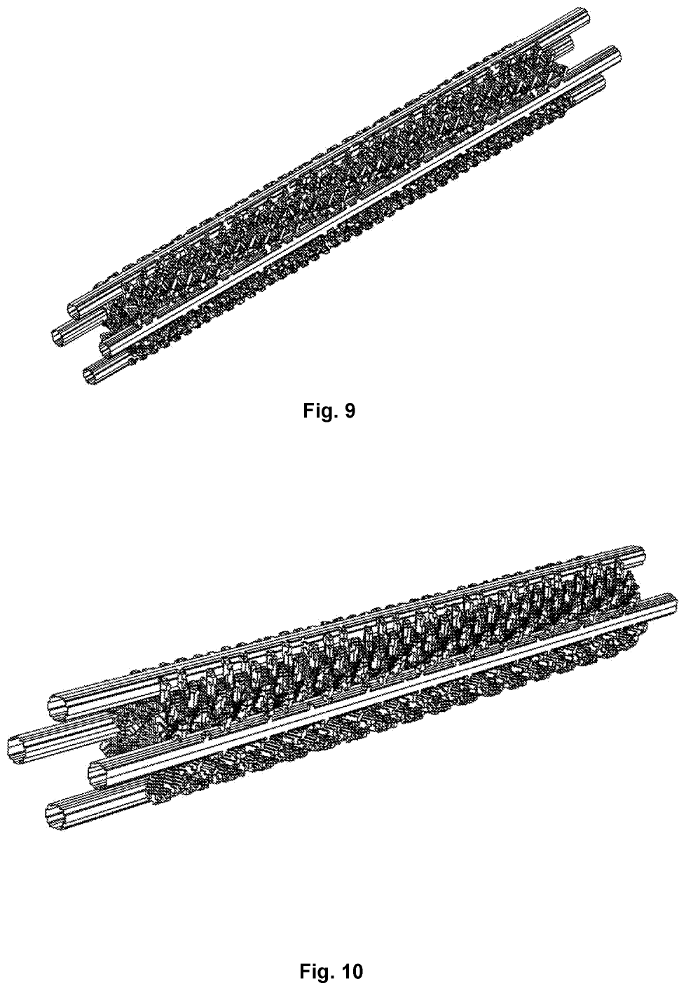

The inventors tested two different families of designs—a one-post structure (previously referred to as tree-like and as depicted in FIG. 2) and a four-post structure (referred to as ribbon and as depicted in FIGS. 3 to 5). In total four new and different designs were 3D Printed and then tested experimentally. The inventors also tested an existing prior art design to compare the improvement in performance. All the new (computer predicted) designs performed better than the existing prior art design tested. The best performing mixers showed a 45% improvement in amount of copper extracted over a four-hour period compared to the existing prior art design.

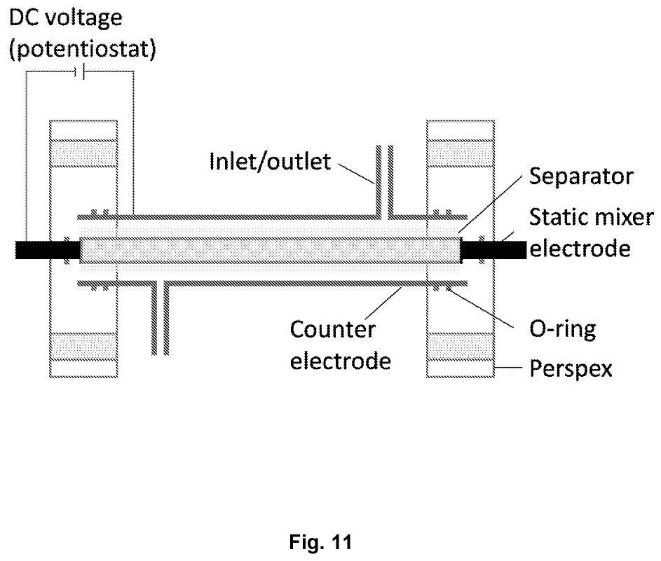

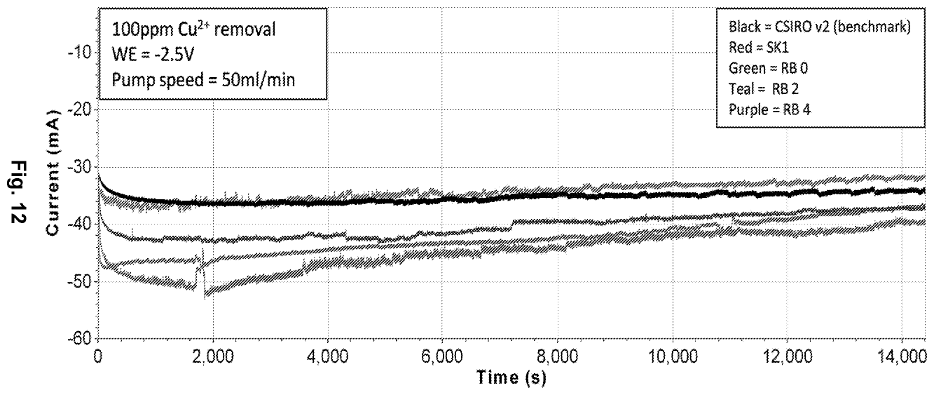

After an extensive optimisation of the static mixer design to optimise transport to the surface of the static mixer, a select number of representative static mixer electrodes were printed in stainless steel and evaluated for their ability to electrochemically plate copper from a 200 ppm copper ion solution. Experiments were conducted with 2 litres of 100 ppm Cu²⁺ 0.01M H₂SO₄ solution prepared with Milli-Q water, which was recirculated through the electrochemical reactor for a maximum of 24 hrs. Reglo-D peristaltic pumps were used for testing solution recirculation and set to a static flow rate of 50 mL/min, feeding both the interstitial space between the separator and the through the inlet of the static mixer. Electrochemical assessment was conducted with a Biologic SP-150 Potentiostat operating in a chronoamperometric testing sequence biasing the working electrode (WE) at −2.5V, in this configuration, the static mixer was the WE and the counter electrode (CE) was the outer shell of the flow reactor, a 20 μm separator (GenPore Reading, USA) was used to separate the CE and WE. Aliquots of testing solution were extracted from the reticulated testing solution at regular intervals, and subsequently analysed for the remaining Cu²⁺ concentration using an Agilent 5900 ICP-OES. A schematic representation of the electrochemical flow reactor utilised in this experiment is illustrated in FIG. 11. In particular, FIG. 11 is a schematic representation of an electrochemical flow reactor 700, according to an embodiment.

A set of experiments were carried out with the prior art Static-Mixer Electrode (SME) previously described in the literature and denoted here as CSIRO v2 mixer (FIG. 1). In the evolution of the static mixer design, a design geometry was established featuring a single central post (SK1), see FIG. 2. With the aim of improving the rigidity of the design, four support posts traversing the axial length of the mixing element, positioned at 90° intervals around the static mixer was introduced. These mixers are called ribbon mixers and are as depicted in FIGS. 3 to 5.

Three different designs were experimentally evaluated to ascertain the performance sensitivity towards the optimised substrate transport mode of operation. In all cases the entire length of the mixer was covered with ribbons, which provided improved performance over the SK1 mixer. The three ribbon mixers are denoted RB0, RB2 and RB4.

The performance of the five static mixer electrodes that were experimentally tested—CSIRO v2, SK1, RB0, RB2 and RB4 was compared. Here the substrate transport and bulk mixing values as calculated by the Lattice Boltzmann method, were calculated as the percentage of tracer particles achieving impact with the substrate or mixing in the bulk of the liquid phase as the tracers traverse the length of the mixing element. It can be clearly seen that the CSIRO v2 mixer has an extremely low substrate transport, which is reflected in the 55 ppm Cu²⁺ ion removal rate after 4 hrs of operation.

Despite having a 20% lower surface area than the reference, the SK1 mixer performance exceed that of the reference, which has been ascribed to the improve substrate transport over the reference. Unlike SK1, the ribbon mixers had a substantially higher surface area (˜70%) than the reference mixer, due to the utilisation of the ribbon motif across the entire length of the mixing element. This was also coupled with improved substrate transport characteristics over the reference and SK1, which also corresponded with enhanced Cu²⁺ ion removal during after 4 hrs of operation.

Note that the surface area change is calculated with respect to the reference mixing element. The asterisk symbol in second row of Table 1 denotes linear interpolation between available data points and is an estimation.

| | | | | Surface | Copper ion |
|---|---|---|---|---|---|
| | Substrate | Bulk | | area | removal at |
| Mixer | transport | mixing | Area | change | 4 hrs |
| reference | (%) | (%) | (mm²) | (%) | (ppm) |
| CSIRO v2 | 3 | 45 | 2126 | — | 55 |
| (Reference) | | | | | |
| Tree (SK1) | 37 | 48 | 1699 | −20 | 61* |
| Ribbon (RB0) | 46 | 53 | 3672 | 73 | 80 |
| Ribbon (RB2) | 57 | 38 | 3715 | 75 | 77 |
| Ribbon (RB4) | 48 | 44 | 3587 | 69 | 76 |

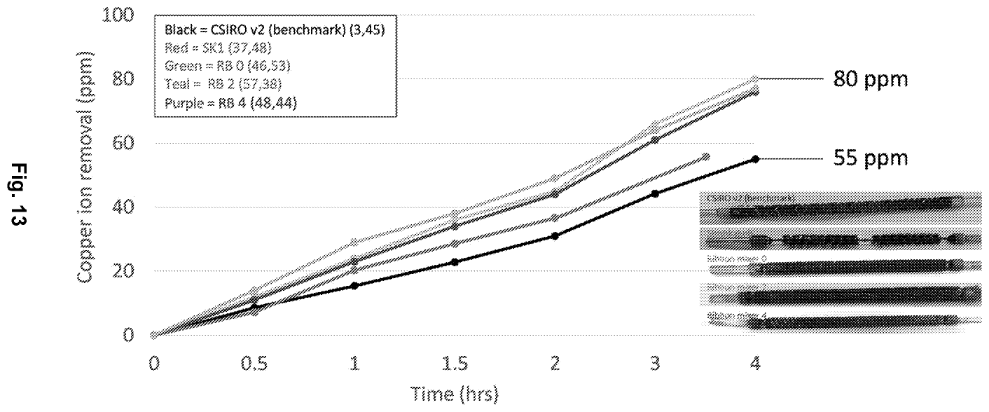

FIG. 12 is a graph illustrating the chronoamperometric response of the experimentally evaluated static mixers in a electrochemical flow reactor, according to an embodiment. FIG. 13 is a graph illustrating the corresponding copper ion removal rate as determined by ICP-OES, for the static mixers featured in FIG. 12, according to an embodiment.

The corresponding chronoamperometric response of each static mixer is presented in FIG. 12, the CSIRO v2 benchmark is depicted in black. It can be clearly seen that all ribbon mixers supported a relatively higher steady state current than the CSIRO v2 mixer, in the first 4 hours of testing. SK1 was observed to outperform the CSIRO v2 mixer, with a cross-over point occurring at approximately 1800s where the steady state current is lower than the reference.

In addition to the electrochemical reduction of copper, the current depicted in FIG. 12 is also a function of the electrolysis of water. Hence it would be inappropriate to directly attribute an increased current with increased copper plating performance. Thus, in order to verify the performance of each static-mixer, the removal of copper ions from solution as a function of time was employed as a conclusive measure of electrochemical performance. This was achieved through the removal of an aliquot of reticulated testing solution for analysis via ICP-OES against known standards. In this set of experiments the electrochemical flow reactor was configured to minimise the electrolysis of water e.g. the evolution of hydrogen and oxygen gas. However, the reactor could be reconfigured to promote the formation of hydrogen gas.

The copper ion removal performance of the evaluated mixers is depicted in FIG. 13. Over the first four hours, the performance of the CSIRO v2 mixer recovers the least amount of copper from solution of any static mixer evaluated, removing 55 ppm Cu²⁺ from solution. Interestingly the SK1 mixer performs marginally better than CSIRO v2 while the three ribbon mixers all perform approximately the same, extracting approximately 80 ppm after four hours. The inventors found that the ribbon mixers were found to be approximately 45% better at removing Cu²⁺ from solution than the CSIRO v2 mixer, under identical electrochemical flow reactor conditions.

All static mixers were found to effectively remove copper from the testing solution within a 24 hr testing period.

1. A static mixer element comprising an elongated integral scaffold, wherein the scaffold comprises plurality of polytope projections in (i) a radially or axially arranged network or (ii) a spiral ribbon of polytope projections to define a plurality of passages configured for mixing one or more fluidic reactants during flow and reaction thereof through the mixer, wherein the static mixer element comprises at least one elongated support member, wherein at least a portion of the plurality of projections are in connection with the elongated support member.

2. The static mixer element of claim 1, wherein the projections extend radially or axially to form an outer perimeter of the static mixer element.

3. The static mixer element of any one of claim 1 or 2, wherein a volume displacement % of each static mixer element relative to the outer perimeter of the static mixer element is less than about 70%.

4. The static mixer element of any one of claims 1 to 3, wherein the projections form a continuous network of passages arranged in multiple orientations relative to one another.

5. The static mixer element of any one of claims 1 to 4, wherein the projections are polytope structures repeated periodically along the longitudinal axis of the elongated support member.

6. The static mixer element of claim 5, wherein the projections are the same polytope structures or are selected from at least two different types of polytope structures.

7. The static mixer element of claim 6, wherein the polytope structure is a polygonal or polyhedral structure.

8. The static mixer element of claim 6 or claim 7, wherein the polytope structure is a regular or irregular triangular shaped polytope, preferably an irregular shaped polytope.

9. The static mixer element of claim 7 or claim 8, wherein the polytope structure is a scalene triangle, isosceles triangle, or equilateral triangle, preferably the polytope structure is a scalene or isosceles triangle.

10. The static mixer element of claim 8 or 9, wherein the polytope structure is a 2-dimensional polygon structure or a 3-dimensional polyhedron structure.

11. The static mixer element of any one of the preceding claims, wherein the projections are connected to each other via at least a portion of at least one surface of a projection to form a continuous interconnected network of projections.

12. The static mixer element of claim 11, wherein at least a portion of the interconnected network of projections are structurally connected to at least one elongated support member.

13. The static mixer element of claim 11 or 12, wherein at least a portion of the interconnected network of projections are structurally connected to at least two elongated support members, preferably at least three elongated projections, even more preferably at least four elongated support members.

14. The static mixer element of any one of claims 11 to 13, wherein the projections are structurally connected at an angle of less than about 90°.

15. The static mixer element of any one of the preceding claims, wherein the scaffold comprises two or more sets of projections, wherein each set of projections are spaced apart from each other and extend radially from a centrally located elongated support member.

16. The static mixer element of claim 15, wherein each set of projections is repeated periodically along the longitudinal axis of the elongated support member.

17. The static mixer element of claim 16, wherein each set of projections comprises a polytope structure.

18. The static mixer element of claim 17, wherein the polytope structure is an elongated polyhedron structure.

19. The static mixer element of claim 18, wherein the elongated polyhedron structure is cylindrical structure or a cone structure.

20. The static mixer element of claim 19, wherein the cylindrical structure is a branched cylindrical structure.

21. The static mixer element of any one of claims 15 to 20, wherein the projections are tree-shaped.

22. The static mixer element of any one of the claims 15 to 21, wherein the projections are stepped projections.

23. The static mixer element of any one of claims 15 to 22, wherein the number of projections per set of projections is in a range between 1 and 2000.

24. The static mixer element of any one of claims 15 to 23, wherein the density of the projections is in a range between about 1 projection per mm to about 50 projections per mm.

25. The static mixer element of any one of claims 15 to 23, wherein each set of projections are equally spaced apart for each other forming segments, wherein each segment comprises at least two sets of projections.

26. The static mixer of claim 25, wherein each segment is equally spaced apart from each other.

27. A static mixer element comprising an elongated integral scaffold, wherein the scaffold comprises an interconnected network of spiral ribbon projections of polytope structures that form a plurality of passages configured for mixing one or more fluidic reactants during flow and reaction thereof through the mixer, and at least one elongated support member, wherein at least a portion of the projections are in connection with the elongated support element.

28. The static mixer element of claim 27, wherein the scaffold comprises at least two spaced apart elongated support members that are structurally connected via the interconnected network of projections.

29. The static mixer element of claim 27 or claim 28, wherein the projections extend radially from the elongated support members to form an outer perimeter of the element.

30. The static mixer element of claim 31, wherein the volume displacement % of each static mixer element relative to the outer perimeter of the static mixer element is less than about 70%.

31. The static mixer element of any one of claims 27 to 30, wherein the scaffold comprises at least three spaced apart elongated support members.

32. The static mixer element of any one of claims 27 to 31, wherein the scaffold comprises at least four spaced apart elongated support members.

33. The static mixer element of any one of claims 27 to 32, wherein the density of the projections is in a range between about 1 projection per mm to about 50 projections per mm.

34. The static mixer element of any one of claims 27 to 33, wherein the projections are polytope structures repeated periodically along the longitudinal axis of the elongated support member.

35. The static mixer element of any one of claims 27 to 34, wherein the projections are the same polytope structures or are selected from at least two different types of polytope structures.

36. The static mixer element of any one of claims 27 to 35, wherein the polytope structure is a polygonal or polyhedral structure.

37. The static mixer element of any one of claims 27 to 35, wherein the polytope structure is a regular or irregular triangular shaped polytope, preferably an irregular shaped polytope.

38. The static mixer element of any one of claims 27 to 37, wherein the polytope structure is a scalene triangle, isosceles triangle, or equilateral triangle, preferably the polytope structure is a scalene or isosceles triangle.

39. The static mixer element of any one of claims 27 to 38, wherein the polytope structure is a 2-dimensional polygon structure or a 3-dimensional polyhedron structure.

40. The static mixer element of claim 39, wherein the 3-dimensional polyhedron structure comprises triangular prisms, square based pyramids or triangle based pyramids.

41. The static mixer element of any one of claims 27 to 40, wherein the projections are connected to each other via at least a portion of at least one surface of a projection to form a continuous interconnected network of projections.

42. The static mixer element of claim 41, wherein at least a portion of the interconnected network of projections are structurally connected to at least one elongated support member.

43. The static mixer element of claim 41 or claim 42, wherein at least a portion of the interconnected network of projections are structurally connected to at least two elongated support members, preferably at least three elongated projections, even more preferably at least four elongated support members.

44. The static mixer element of any one of claims 41 to 43, wherein the projections are structurally connected at an angle of less than about 90°.

45. The static mixer element of any one of claims 27 to 44, wherein the projections form a continuous network of passages arranged in multiple orientations relative to one another.

46. A static mixer element comprising an elongated integral scaffold, wherein the scaffold comprises two or more sets of projections, wherein each set of projections are spaced apart from each other and extend radially from a centrally located elongated support member to define a plurality of passages configured for mixing one or more fluidic reactants during flow and reaction thereof through the mixer.

47. The static mixer element of claim 46, wherein the projections extend radially to form an outer perimeter of the static mixer element.

48. The static mixer element of claim 47, wherein the volume displacement % of each static mixer element relative to the outer perimeter of the static mixer element is less than about 70%.

49. The static mixer element of any one of claims 46 to 48, wherein the number of projections per set of projections is in a range between 1 and 2000.

50. The static mixer element of any one of claims 46 to 49, wherein the density of the projections is in a range between about 1 projection per mm to about 50 projections per mm.

51. The static mixer element of any one of claims 46 to 50, wherein each set of projections comprises polytope structures repeated periodically along the longitudinal axis of the elongated support member.

52. The static mixer element of claim 51, wherein the polytope structure is an elongated polyhedron structure.

53. The static mixer element of claim 52, wherein the elongated polyhedron structure is cylindrical structure.

54. The static mixer element of claim 53, wherein the cylindrical structure is a branched cylindrical structure.

55. The static mixer element of any one of claims 46 to 54, wherein the projections are tree-shaped.

56. The static mixer element of any one of the claims 46 to 55, wherein the projections are stepped projections.

57. The static mixer element of any one claims 46 to 55, wherein each set of projections are arranged in multiple orientations relative to one another.

58. The static mixer element of any one of claims 46 to 57, wherein each set of projections are equally spaced apart for each other forming segments, wherein each segment comprises at least two sets of projections.

59. The static mixer of claim 58, wherein each segment is equally spaced apart from each other.

60. The static mixer element of any one of the preceding claims, wherein the elongated support member is an elongated polygonal prism.

61. The static mixer element of any one of the preceding claims, wherein the length (in mm) of the elongated support member are in a range between 1 and 5000.

62. The static mixer element of any one of the preceding claims, wherein the diameter (in mm) of the elongated support member are in a range between 1 and 5000.

63. The static mixer element of any one of the preceding claims, wherein the area (in m²) of the elongated support member are in a range between 0.001 and 1000.

64. The static mixer element of any one of the preceding claims, wherein the length (in mm) of the projections are in a range between 1 and 500.

65. The static mixer element of any one of the preceding claims, wherein the diameter (in mm) of the projections are in a range between 1 and 50.

66. The static mixer element of any one of the preceding claims, wherein the area (in m²) of the projections are in a range between 0.001 and 1.

67. The static mixer element of any one of the preceding claims, wherein at least a portion of a surface of the scaffold comprises a catalytic material for providing the surface with catalytically reactive sites.

68. The static mixer element of any one of the preceding claims, wherein the catalytically reactive sites are provided by at least one of: the scaffold being formed from a catalytic material: a catalyst material being intercalated, interspersed and/or embedded with at least part of the scaffold; and at least a part of the surface of the scaffold comprising a coating comprising a catalyst material.

69. The static mixer element of any one of the preceding claims, wherein the scaffold comprises or consists of a metal, metal alloy, metal oxide, ceramic, cermet, composite material, glass, polymer, a natural product, and combinations or derivatives thereof.

70. The static mixer element of any preceding claims, wherein the static mixer element has a diameter (in mm) in the range of 1 to 5000.

71. The static mixer element of any preceding claims, wherein the static mixer element has an aspect ratio in the range of about 1 to 1000.

72. The static mixer element of any preceding claims, wherein each static mixer element has an aspect ratio of at least 15.

73. The static mixer element of any one of the preceding claims, wherein the scaffold is configured for operating in a turbulent flow with a Reynolds numbers (Re) of at least about 2500.

74. A catalytic static mixer element comprising catalytic reactive sites on the static mixer of any one of the preceding claims.

75. A continuous flow chemical reactor for use in reaction of one or more fluidic reactants, the reactor comprising one or more static mixer elements of any one of claims 1 to 46 or the catalytic static mixer of claim 74.

76. The continuous flow chemical reactor of claim 75 comprising one or more catalytic static mixer inserts and at least one chamber section configured for receiving and housing the insert.

77. The continuous flow chemical reactor of claim 75 or claim 76 comprising:
one or more chamber sections in fluidic communication with each other, wherein at least one chamber section comprises the static mixer element disposed therein for dispersing and mixing the one or more fluidic reactants during flow and reaction thereof through the mixer;
one or more reactant inlets for supply of the one or more fluidic reactants to the one or more chamber sections;
one or more outlets in fluidic communication with the static mixer for receiving an output stream comprising a product of the reaction.

78. The continuous flow chemical reactor of any one of claims 75 to 77, wherein the reactor is a tubular reactor.

79. The continuous flow chemical reactor of any one of claims 75 to 78, wherein the volume displacement % of the static mixer relative to a reactor chamber for containing the mixer is less than about 70.

80. The continuous flow chemical reactor of any one of claims 75 to 79, wherein the reactor comprises a heat exchanger system to allow control of the temperature of the reactor, chamber section, catalytic static mixer, or fluidic components thereof.

81. The continuous flow chemical reactor of any one of claims 75 to 80, wherein the heat exchanger system comprises a controller to control the temperature of the reactor, chamber section, catalytic static mixer, or fluidic components thereof.

82. The continuous flow chemical reactor of claim 81, wherein the heat exchanger system comprises a shell and tube heat exchanger.

83. A system for providing a continuous flow chemical reaction comprising:
a continuous flow chemical reactor comprising a static mixer according to any one of claims 1 to 73, the catalytic static mixer element of claim 74 or a continuous flow chemical reactor according to any one of claims 75 to 82;
a pump for providing fluidic flow for one or more fluidic reactants and any products thereof through the reactor;
one or more heat exchangers to allow for control of the temperature of the reactor, chamber section, static mixer, or fluidic components thereof; and
a controller for controlling one or more of the parameters of the system selected from concentration, flow rate, temperature, pressure, and residence time, of the one or more fluidic reactants, or sources or products thereof.

84. A process for extracting a metal from one or more fluidic reactants, the process comprising the steps of:
providing a continuous fluid flow reactor according to any one of claims 75 to 82 or a system according to claim 83;
providing at least a first fluidic reactant to the reactor via the one or more reactant inlets;
operating the reactor, or control means thereof, to provide flow and reaction of the at least first fluidic reactant through the static mixer; and
adsorption of a substance from the at least first reactant to at least a portion of the surface of the static mixer and obtaining an output stream comprising a product of a reaction of the at least first reactant in which the substance is extracted.
